(19) United States
(12) Patent Application Publication
(10) Pub. No.: US 2020/0333777 A1
(43) Pub. Date: Oct. 22, 2020

(54) ABNORMALITY DETECTION METHOD AND ABNORMALITY DETECTION APPARATUS

(71) Applicant: TOKYO ELECTRON LIMITED, MInato-ku,Tokyo (JP)

(72) Inventor: Kou MARUYAMA, Tokyo (JP)

(21) Appl. No.: 16/336,744

(22) PCT Filed: Sep. 15, 2017
(86) PCT No.: PCT/JP2017/033577

§ 371 Date: Mar. 26, 2019

(30) Foreign Application Priority Data
Sep. 27, 2016 (JP) 2016-188280

(51) Int. Cl. G05B 23/02; G06N 7/00

(52) U.S. Cl. CPC G05B 23/0254; G06N 7/005

(57) ABSTRACT

An abnormality detection apparatus acquires observation values serving as indexes of an operating state of a monitoring target apparatus at predetermined timings in a process executed repeatedly in the monitoring target apparatus. The abnormality detection apparatus applies statistical modeling to a summary value acquired by summarizing the observation values, to estimate a state in which noise is removed from the summary value, and generate a predictive value acquired by predicting a summary value of a next period based on the estimating. The abnormality detection apparatus detects presence/absence of abnormality of the monitoring target apparatus based on the predictive value.

### FIELD

The present invention relates to an abnormality detection program, an abnormality detection method, and an abnormality detection apparatus.

### BACKGROUND

In the process of manufacturing a semiconductor, a recipe, that is, flow and details of the process are set in advance. The semiconductor manufacturing apparatus manufactures a semiconductor of a desired quality, when it is controlled in accordance with the recipe and executes the process. The state in which the semiconductor manufacturing apparatus is in a desired controlled state is referred to as “stable operation state”.

Conventionally, a control chart, such as a Shewhart control chart, is used to monitor whether the semiconductor manufacturing apparatus is in the stable operation state, and detect abnormality of the semiconductor manufacturing apparatus. In abnormality detection using a control chart, data during execution of each recipe is acquired from a sensor provided in the semiconductor manufacturing apparatus in advance, and summary values, such as a mean value and variations, are calculated from the acquired data. In addition, the calculated summary values are plotted in time series, and the upper limit threshold and the lower limit threshold (or one of them) are set. When the summary value falls out of the threshold, it is determined that abnormality has occurred. A fixed value or 3σ is used as the threshold.

Known methods for detecting abnormality as described above, include a method of detecting a sign of abnormality of the semiconductor manufacturing apparatus based on apparatus log information, such as information relating to operation and driving of the semiconductor manufacturing apparatus and information relating to the internal state of the processing chamber (Patent Literature 1). An abnormality sign diagnostic apparatus has also been presented (Patent Literature 2). The abnormality sign diagnostic apparatus is configured to continue diagnosis also during maintenance of the mechanical equipment. The abnormality sign diagnostic apparatus learns a normal model based on time-series data relating to devices continuing to operate during the maintenance period among a plurality of devices included in the mechanical equipment, and continues to perform diagnosis also during the maintenance period. In addition, an abnormality diagnostic apparatus performing abnormality diagnosis on a process system, and an apparatus of estimating judgment of the operator in the process system have been presented (Patent Literature 3).

### CITATION LIST

### Patent Literature

Patent Literature 1: Japanese Patent Application Laid-open No. 2010-283000
Patent Literature 2: Japanese Patent Application Laid-open No. 2015-108886
Patent Literature 3: Japanese Patent Application Laid-open No. 2012-9064

### Non Patent Literature

Non Patent Literature 1: Kei IMAZAWA, et al., “Development of Potential Failure Detection System for Semiconductor Manufacture Equipment”, Journal of the Japan Society for Precision Engineering, 20105(0), 223-224, 2010, The Japan Society for Precision Engineering

### Summary

### Technical Problem

However, in conventional technique, difficulty exists in achievement of abnormality detection with high accuracy and efficiency for semiconductor manufacturing apparatuses.

Sensors provided to check the control state of the semiconductor manufacturing apparatus are large in number and types. In addition, the sensors are dynamically controlled and interact and interfere with each other. The sensors are also influenced with chronological change. For this reason, in each process of semiconductor manufacturing, the sensor outputs are not always reproduced completely.

For example, in the case of abnormality detection based on the conventional control chart, the summary value has low reproducibility in a process with an extremely small number of samples, such as a process finished within a short time, a process in which noise and/or observation error greatly influences on the output values of the sensors, and a process with a large dynamic change. For this reason, accurate abnormality detection is difficult in the method using a conventional control chart for semiconductor manufacturing apparatuses.

In addition, the thresholds to detect abnormality are set by the operator handling the semiconductor manufacturing apparatus based on past data. For this reason, accuracy of abnormality detection depends on the operator's experience.

Besides, when maintenance or the like is performed on the semiconductor manufacturing apparatus, the output values from the sensors may greatly fluctuate before and after the maintenance. In addition, the state of the semiconductor manufacturing apparatuses changes with a lapse of time. Besides, machine difference and/or individual difference between sensors exist in each of the semiconductor manufacturing apparatuses. For this reason, to achieve abnormality detection with high accuracy, it is necessary to frequently adjust the thresholds in accordance with the current state of the semiconductor manufacturing apparatus, requiring labor and time.

In addition, in the case of providing a large-scale abnormality detection service for a plurality of semiconductor manufacturing apparatuses using cloud computing or the like, manually adjusting the thresholds and the like for the individual apparatuses as in prior art requires much labor and is not practical.

### Solution to Problem

In the embodiment disclosed, an abnormality detection apparatus, an abnormality detection method, and an abnormality detection program apply statistical modeling to a summary value acquired by summarizing observation values. The observation values being acquired at predetermined timings during a process executed repeatedly in a monitoring target apparatus and serving as indexes of an operating state of the monitoring target apparatus. Then, an abnormality detection apparatus, an abnormality detection method, and an abnormality detection program estimate a state in which noise is removed from the summary value, and generate a predictive value acquired by predicting a summary value of a next period based on the estimation. Then, an abnormality detection apparatus, an abnormality detection method, and an abnormality detection program detect presence/absence of abnormality of the monitoring target apparatus based on the predictive value.

### Advantageous Effects of Invention

The disclosed exemplary embodiments have an effect of achieving accurate and efficient abnormality detection.

### BRIEF DESCRIPTION OF DRAWINGS

FIG. 1 is a diagram illustrating an example of configuration of an abnormality detection apparatus executing an abnormality detection method according to a first embodiment.

FIG. 2 is a diagram for explaining abnormality score calculation process according to the first embodiment.

FIG. 3 is a diagram illustrating an example of configuration of semiconductor manufacturing apparatus information stored in the abnormality detection apparatus according to the first embodiment.

FIG. 4 is a diagram illustrating an example of configuration of abnormality detection information stored in the abnormality detection apparatus according to the first embodiment.

FIG. 5 is a diagram illustrating an example of information output by an abnormality detection process according to the first embodiment.

FIG. 6 is a diagram for explaining an example of a predictive value, an abnormality score, and a change score generated by the abnormality detection process according to the first embodiment.

FIG. 7 is a flowchart illustrating an example of the abnormality detection process according to the first embodiment.

FIG. 8 is a flowchart for explaining a process in the abnormality detection apparatus according to a first alternative example according to the first embodiment.

FIG. 9 is a flowchart for explaining a process in the abnormality detection apparatus according to a second alternative example according to the first embodiment.

FIG. 10 is a diagram illustrating that information processing with an abnormality detection program according to the first embodiment can be achieved using a computer.

FIG. 11 is a diagram illustrating an example of a conventional control chart.

### DESCRIPTION OF EMBODIMENTS

In a disclosed embodiment, an abnormality detection program causes a computer to execute a predictive value generation process and a detection process. At the predictive value generation process, the computer applies statistical modeling to a summary value acquired by summarizing observation values, to estimate a state in which noise is removed from the summary value, and generate a predictive value acquired by predicting a summary value of a next period based on estimating. The observation values are acquired at predetermined timings during a process executed repeatedly in a monitoring target apparatus, and serve as indexes of an operating state of the monitoring target apparatus. At the detection process, the computer detects presence/absence of abnormality of the monitoring target apparatus based on the predictive value.

In a disclosed embodiment, the abnormality detection program causes the computer, at the predictive value generation process, to successively execute a prediction model as the statistical modeling whenever a new summary value is acquired and update the predictive value. At the detection process, the abnormality detection program causes the computer to set a predetermined confidence interval of the updated predictive value as upper and lower thresholds and detect abnormality of the monitoring target apparatus.

In a disclosed embodiment, the abnormality detection program causes the computer, at the predictive value generation process, to apply a prediction model using filtering as the statistical modeling and generate the predictive value.

In a disclosed embodiment, the abnormality detection program causes the computer, at the predictive value generation process, to generate a filtered value or a smoothed value acquired by Kalman filtering, as the predictive value.

In a disclosed embodiment, the abnormality detection program causes the computer, at the predictive value generation process, to apply a prediction model using Markov Chain Monte Carlo Method as the statistical modeling to generate the predictive value.

In a disclosed embodiment, the abnormality detection program causes the computer, at the predictive value generation process, to estimate posterior distribution with the prediction model using Markov Chain Monte Carlo Method, to generate one of a mean value, a mode, and a median of the posterior distribution as the predictive value.

In a disclosed embodiment, the abnormality detection program causes the computer, at the detection process, to detect abnormality when at least one of a residual between the predictive value and the summary value, square of the residual, and a standardized residual between the predictive value and the summary value is larger than a threshold.

In a disclosed embodiment, the abnormality detection program causes the computer, at the predictive value generation process, to apply a prediction model and a change point detection model as the statistical modeling.

In a disclosed embodiment, the abnormality detection program causes the computer, at the detection process, to detect abnormality when a score of a Bayesian change point of the summary value exceeds a threshold.

In a disclosed embodiment, an abnormality detection method is executed with a computer, and the method includes: a predictive value generation process of applying statistical modeling to a summary value acquired by summarizing observation values, estimating a state in which noise is removed from the summary value, and generating a predictive value acquired by predicting a summary value of a next period based on estimating, the observation values acquired at predetermined timings during a process executed repeatedly in a monitoring target apparatus and serving as indexes of an operating state of the monitoring target apparatus; and a detection process of detecting presence/absence of abnormality of the monitoring target apparatus based on the predictive value.

In a disclosed embodiment, the abnormality detection method further includes: an output process of outputting, with the computer, a table in which a threshold and at least one of a residual between the predictive value and the summary value, square of the residual, and a standardized residual between the predictive value and the summary value are displayed in a vertical axis, and a time axis is displayed in a horizontal axis.

In a disclosed embodiment, the abnormality detection method further includes: an output process of outputting, with the computer, a table in which a score of a Bayesian change point of the summary value and a threshold are displayed in a vertical axis, and a time axis is displayed in a horizontal axis.

In a disclosed embodiment, the abnormality detection method further includes: an output process of outputting, with the computer, a first table in which a threshold and at least one of a residual between the predictive value and the summary value, square of the residual, and a standardized residual between the predictive value and the summary value are displayed in a vertical axis, and a time axis is displayed in a horizontal axis, and a second table in which a score of a Bayesian change point of the summary value and a threshold are displayed in a vertical axis, and a time axis is displayed in a horizontal axis, as an image in which the first table and the second table are aligned with the time axes thereof aligned.

In a disclosed embodiment, an abnormality detection apparatus includes: a predictive value generation unit and a detection unit. The predictive value generation unit applies statistical modeling to a summary value acquired by summarizing observation values, to estimate a state in which noise is removed from the summary value, and generate a predictive value acquired by predicting a summary value of a next period based on estimating. The observation values are acquired at predetermined timings during a process executed repeatedly in a monitoring target apparatus, and serve as indexes of an operating state of the monitoring target apparatus. The detection unit detects presence/absence of abnormality of the monitoring target apparatus based on the predictive value.

In a disclosed embodiment, the abnormality detection apparatus further includes: a preparation unit preparing a table in which a threshold and at least one of a residual between the predictive value and the summary value, square of the residual, and a standardized residual between the predictive value and the summary value are displayed in a vertical axis, and a time axis is displayed in a horizontal axis; and an output unit outputting the table prepared with the preparation unit.

In a disclosed embodiment, the abnormality detection apparatus further includes: a preparation unit preparing a table in which a score of a Bayesian change point of the summary value and a threshold are displayed in a vertical axis, and a time axis is displayed in a horizontal axis; and an output unit outputting the table prepared with the preparation unit.

In a disclosed embodiment, the abnormality detection apparatus further includes: a preparation unit preparing a first table in which a threshold and at least one of a residual between the predictive value and the summary value, square of the residual, and a standardized residual between the predictive value and the summary value are displayed in a vertical axis and a time axis is displayed in a horizontal axis, and a second table in which a score of a Bayesian change point of the summary value and a threshold are displayed in a vertical axis and a time axis is displayed in a horizontal axis; and an output unit outputting the first table and the second able as an image in which the first table and the second table are aligned with the time axes thereof aligned.

The disclosed embodiment will be explained in detail hereinafter with reference to drawings. The present embodiment does not limit the disclosed invention. Each of the embodiments may properly be combined within a range in which the details of the processes are not contradictory.

Before an explanation of the embodiment, the following is an explanation of a control chart used in conventional abnormality detection, as a premise.

Example of Conventional Control Chart

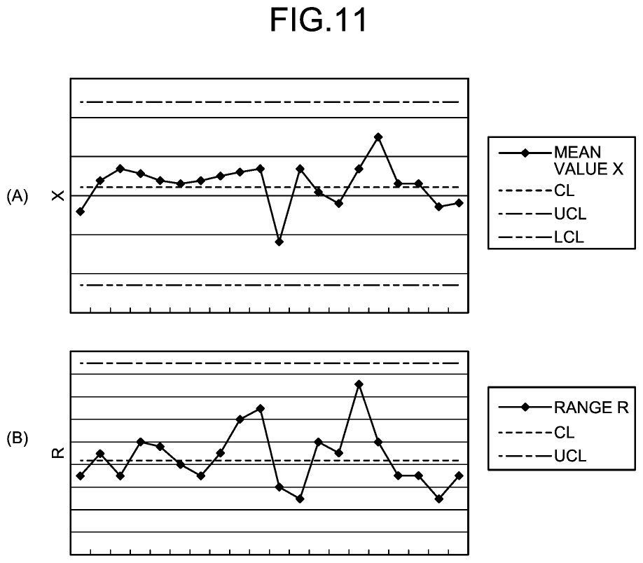

FIG. 11 is a diagram illustrating an example of a conventional control chart. This example illustrates the case of generating an X bar-R control chart of a manufacturing apparatus manufacturing 1000 products A per lot. First, five samples are extracted from a lot to calculate a mean value of predetermined parameters of the five samples. In addition, variation (range) of predetermined parameters of the five samples is calculated. In the case of preparing a control chart for 20 lots, five samples are extracted from each of 20 lots to calculate the mean value and variation in the same manner. Thereafter, a mean value of the mean values of the 20 lots is calculated. A mean value of variations of the 20 lots is also calculated. A center line CL of FIG. 11 (A) indicates the mean value of the mean values, and a center line CL of FIG. (B) indicates a mean value of the variations.

Thereafter, an upper control limit UCL and a lower control limit LCL are calculated based on a predetermined coefficient and the two mean values calculated above. The control chart illustrated in FIG. 11 is acquired by plotting the calculated upper control limit UCL, the lower control limit LCL, and the mean values calculated for the respective lots in a table. On the control chart, a lot having a value falling out of a range between the upper control limit UCL and the lower control limit LCL is determined as an abnormal lot. The control chart using a fixed value as a threshold as described above is effective when the determination standard (limit value) for performance is clear. By contrast, in the case where it is difficult to clearly set the determination standard (limit value) for performance as the fixed value, abnormality determination using only a control chart is insufficient.

### First Embodiment

An abnormality detection apparatus according to the first embodiment applies statistical modeling to the summary values, such as a mean value of the observation values, to estimate a state acquired by removing a system noise and an observation noise from the summary value of the observation values. In addition, the abnormality detection apparatus generates a value predicted as a summary value at the point in time (next period) at which the observation value is acquired next, that is, a predictive value based on the estimated state. When a summary value is generated from the next observation value, the abnormality detection apparatus generates the predictive value of the second next period based on the summary value. As described above, the abnormality detection apparatus according to the embodiment applies a method of statistical modeling, to estimate the true state of the monitoring target apparatus whenever a new summary value is generated, and generate a predictive value estimated as a value that the summary value has at the next point in time. In addition, the abnormality detection apparatus sets the threshold used for abnormality detection based on the predictive value generated at each point in time. For this reason, even in the case of using parameters with which abnormality detection is difficult when the fixed value is used as the threshold, the abnormality detection apparatus is capable of detecting abnormality with high accuracy. In addition, because the abnormality detection apparatus generates the predictive values again from the respective new summary values successively generated to automatically update the threshold for abnormality detection, the abnormality detection apparatus is capable of achieving automatic abnormality detection also in consideration of machine difference and the like.

### Explanation of Terms

Before the embodiments are explained, the terms used in the following explanation will be explained.

“Observation value” means a value actually observed in the monitoring target apparatus, such as the semiconductor manufacturing apparatus. “Observation value” is an actual measurement value, such as the atmospheric pressure, the degree of vacuum, and the temperature, sensed with the sensors arranged in the semiconductor manufacturing apparatus. “Observation value” includes variation (that is, noise of the system and noise of observation) in accordance with, for example, the state of the sensors and the state of the semiconductor manufacturing apparatus.

“Summary value” means a value acquired by extracting a predetermined characteristic included in the observation value. “Summary value” is, for example, a mean value and/or variation (such as standard deviation) of the observation values for a predetermined period, and the mean value, the median, and the weighted average of the variation, and the like.

“Predictive value” means a value predicted as a value that the “summary value” of the next period should have based on the “observation value” or the “summary value”. Specifically, the “predictive value” is a value indicating the summary value predicted for the next period.

The abnormality detection apparatus according to the embodiments described hereinafter applies a method of statistical modeling to estimate the true state from the observation value and generate a predictive value. The abnormality detection apparatus also detects presence/absence of abnormality of the monitoring target apparatus based on the calculated predictive value.

Example of Configuration of Abnormality Detection Apparatus 1

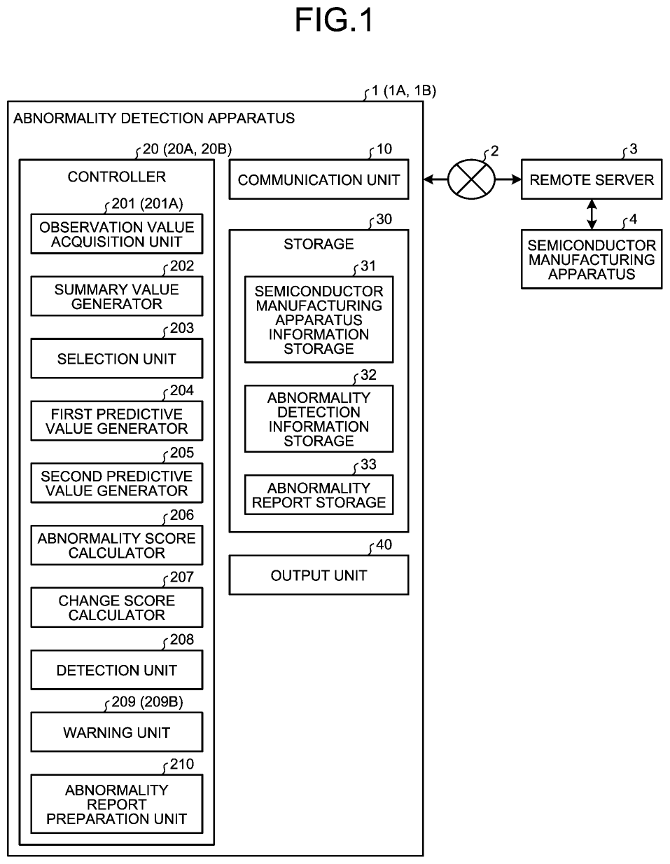

FIG. 1 is a diagram illustrating an example of configuration of an abnormality detection apparatus 1 executing an abnormality detection method according to the first embodiment. The abnormality detection apparatus 1 is connected with a remote server 3 through a network 2. The remote server 3 is connected with a monitoring target apparatus serving as a target of abnormality detection, that is, a semiconductor manufacturing apparatus 4. A predetermined number of sensors are set in the semiconductor manufacturing apparatus 4, to measure predetermined parameters whenever a manufacturing process is executed in the semiconductor manufacturing apparatus 4. The measured parameters are transmitted to the remote server 3. The remote server 3 successively transmits the parameters received from the sensors of the semiconductor manufacturing apparatus 4 to the abnormality detection apparatus 1.

The abnormality detection apparatus 1 is operated by, for example, an operator performing maintenance and management of the semiconductor manufacturing apparatus 4. The remote server 3 is managed by the user who uses the semiconductor manufacturing apparatus 4. For example, the remote server 3 and the semiconductor manufacturing apparatus 4 are installed in the office of the user. The abnormality detection apparatus 1 may be virtually achieved using cloud computing.

The abnormality detection apparatus 1 the remote server 3 are connected with each other to be enabled to perform communication through the network 2. The type of the network 2 connecting them is not particularly limited, but may be any network, such as the Internet, a wide area network, and a local area network. In addition, the network 2 may be either a wireless network or a wired network, or a combination of them. The abnormality detection apparatus 1 is connected with the remote server 3 continuously collecting observation values observed in the semiconductor manufacturing apparatus 4 through the network 2, to achieve online monitoring to always monitor the semiconductor manufacturing apparatus 4 online. Thus, the abnormality detection apparatus 1 can detect abnormality of the semiconductor manufacturing apparatus 4 in real time and notify the user of the abnormality. [0046] The abnormality detection apparatus 1 includes a communication unit 10, a controller 20, a storage 30, and an output unit 40.

The communication unit 10 is a functional unit achieving communications between the abnormality detection apparatus 1 and the remote server 3. The communication unit 10 includes, for example, a port and/or a switch. The communication unit 10 receives information transmitted from the remote server 3. The communication unit 10 also transmits information generated in the abnormality detection apparatus 1 to the remote server 3 under the control of the controller 20.

The controller 20 controls operations and functions of the abnormality detection apparatus 1. The controller 20 can be configured using an integrated circuit and/or an electronic circuit. For example, the controller 20 may be configured using a central processing unit (CPU) and/or a micro processing unit (MPU).

The storage 30 stores therein information used for processes in the units of the abnormality detection apparatus 1 and information generated by processes of the units. Any semiconductor memory element or the like may be used as the storage 30. For example, a random access memory (RAM) or a read only memory (ROM) may be used as the storage 30. As another example, a hard disk or an optical disk may be used as the storage 30.

The output unit 40 outputs information generated in the abnormality detection apparatus 1 and information stored in the abnormality detection apparatus 1. For example, the output unit 40 outputs information by sound and/or an image. The output unit 40 is, for example, a display device displaying information generated in the abnormality detection apparatus 1 and information stored in the abnormality detection apparatus 1. The output unit 40 includes, for example, a speaker, a printer, and/or a monitor, and the like.

The controller 20 includes an observation value acquisition unit 201, a summary value generator 202, a selection unit 203, a first predictive value generator 204, a second predictive value generator 205, an abnormality score calculator 206, a change score calculator 207, a detection unit 208, a warning unit 209, and an abnormality report preparation unit 210.

Example of Observation Value Acquisition Process

The observation value acquisition unit 201 receives observation values acquired with the sensors arranged in the semiconductor manufacturing apparatus 4 through the remote server 3 and the communication unit 10.

In the present embodiment, the sensor acquires a numerical value, that is, an observation value indicating the operating state of the step at predetermined timing of the step executed in the semiconductor manufacturing apparatus 4. For example, when the step is a step executed with the inside of the processing chamber maintained at predetermined atmospheric pressure, the sensor acquires the observation value of the atmospheric pressure in the processing chamber at the time when predetermined time has passed from the start of the process.

The observation value is transmitted from the remote server 3 to the abnormality detection apparatus 1, whenever the one run of process is finished in the semiconductor manufacturing apparatus 4. One run corresponds to, for example, a process for a batch in a batch process, or a process for a wafer in a sheet process. When the same process is repeated a predetermined number of times in one run, a predetermined number of the observation values acquired at predetermined timings of the process are transmitted from the semiconductor manufacturing apparatus 4 to the observation value acquisition unit 201. The observation value is, for example, a trace log of each sensor. The observation values acquired with the observation value acquisition unit 201 are stored in the storage 30.

Example of Summary Value Generation Process

The summary value generator 202 generates a summary value based on the observation values acquired with the observation value acquisition unit 201.

The summary value is a statistic value calculated based on the observation values acquired with the observation value acquisition unit 201 and indicates the operating state of the semiconductor manufacturing apparatus 4 at each point in time. The summary value is, for example, a mean value of the observation values, a mean value of variation, a standard derivation, a median, and the weighted average of the observation values used in the conventional control chart.

The summary value generator 202 classifies the observation values into layers according to the purpose of monitoring. The summary value generator 202 classifies, for example, according to the sensor region, the recipe, and the step. The summary value generator 202 performs preprocessing on the classified observation values. The preprocessing is, for example, a process of disregarding a missing value and/or unnecessary data, removing the trend, and acquiring normal distribution. The summary value generator 202 generates a summary value based on the classified and preprocessed observation values. What value is to be generated as the summary value is set in advance in accordance with the recipe and the property of the step.

Example of Selection Process

The selection unit 203 inputs the summary value to one of the first predictive value generator 204 and the second predictive value generator 205 in accordance with the property of the data acquired before. For example, the selection unit 203 inputs the summary value to one of the first predictive value generator 204 and the second predictive value generator 205 in accordance with whether the data acquired before has normal distribution or non-normal distribution. For example, the selection unit 203 inputs the summary value of the normally distributed data to the first predictive value generator 204. The selection unit 203 inputs the summary value of the non-normally distributed data to the second predictive value generator 205.

For example, in the following explanation, the first predictive value generator 204 generates a predictive value from the summary value using a prediction method using filtering. The prediction method using filtering generates a predictive value based on newly input data. For this reason, the prediction method using filtering is capable of achieving high-speed processing, and suitable for normally distributed observation data.

By contrast, the second predictive value generator 205 generates a predictive value from the summary value using a prediction method using Markov Chain Monte Carlo Method (MCMC). The prediction method using MCMC is a method of generating the predictive value again based on the whole past data (or the whole data for a predetermined past period) including new data, when new data is input. For this reason, the prediction method using MCMC is capable of achieving more accurate estimation, and is suitable for non-normally distributed observation data, although the process is slower than the prediction method using filtering.

For this reason, in the present embodiment, it is set which summary value is to be input to the first predictive value generator 204, and which summary value is to be input to the second predictive value generator 205, in accordance with the type of the observation values input to the abnormality detection apparatus 1 in advance. The setting is stored in the storage 30.

Example of First Predictive Value Generation Process—State Space Model (1)

Thereafter, the first predictive value generator 204 applies first statistical modeling to the summary value generated with the summary value generator 202, to generate a predictive value.

The summary value generated with the summary value generator 202 is still in a state of including noise and/or observation error even after preprocessing is performed. For this reason, in the present embodiment, the first predictive value generator 204 applies statistical modeling to estimate a true summary value, that is, a predictive value acquired by removing noise and/or observation error from the summary value.

For example, the first predictive value generator 204 applies a method of time-series analysis using a state space model to estimate the state from the summary value. For example, in this example, the first predictive value generator 204 applies a prediction method using filtering, such as a Kalman filter, to estimate the state. For example, suppose that the first predictive value generator 204 executes Kalman filtering using a local level model (dynamic linear model). The first predictive value generator 204 causes the summary value to pass through the Kalman filter, to determine optimum likelihood of parameters of the dynamic linear model. The first predictive value generator 204 puts the determined likelihood into the dynamical linear model again to estimate the state from the filtering result.

For example, the first predictive value generator 204 causes the summary value generated from the observation value of time t to pass through the Kalman filter, to estimate the true state of the summary value generated from the observation value at time t+1 to be acquired next. Thereafter, the first predictive value generator 204 generates a predictive value serving as a value predicted as a value that the summary value has at time t+1 based on the estimated state. The predictive value is, for example, a filtered value or a smoothed value.

For example, whenever data (summary value) of the latest run is acquired from the semiconductor manufacturing apparatus 4, the first predictive value generator 204 corrects, with Kalman gain, the error of the predictive value calculated when the summary value of the previous run has been input, to update the predictive value and generate the latest predictive value. The first predictive value generator 204 may partly execute multiple regression estimation also in estimating the state.

As described above, the first predictive value generator 204 generates the predictive value. Generating the predictive value from the summary value as described above enables removal of noise and/or observation error of the summary value (observation value), and extraction of an increase/decrease trend in the summary value.

Example of Second Predictive Value Generation Process—Markov Chain Monte Carlo Method (MCMC)

The second predictive value generator 205 applies second statistical modeling to the summary value generated with the summary value generator 202, to generate a predictive value. The second statistical modeling used with the second predictive value generator 205 is a method different from the first statistical modeling used with the first predictive value generator 204.

For example, as described above, the second predictive value generator 205 applies a prediction method using the Markov Chain Monte Carlo Method (MCMC) to the summary value, to generate the predictive value.

The second predictive value generator 205 uses the Bayes' theorem to use posterior probability generated at the previous summary value acquisition time as prior probability, and calculates the posterior probability by Bayesian estimation to calculate the predictive value. Because the posterior probability acquired by Bayesian estimation is expressed as distribution, the second predictive value generator 205 calculates the mean value (posterior mean value), the mode, or the median of the posterior probability distribution, to use the value as the predictive value.

The second predictive value generator 205 updates the predictive value using the latest summary value, whenever the latest summary value is input. Whenever a new summary value is input, the second predictive value generator 205 applies MCMC to all the pieces of data input up to that time to update the predictive value. As described above, each time the summary value is input, the second predictive value generator 205 regulates the value serving as the base of abnormality detection based on all the pieces of data input up to that time. This structure achieves abnormality detection with higher accuracy than that of abnormality detection using the predictive value generated using filtering, in the case of executing abnormality detection using the predictive value generated using MCMC.

Example of Abnormality Score Calculation Process Based on Predictive Value

The abnormality score calculator 206 calculates an abnormality score serving as an index of presence/absence of abnormality of the semiconductor manufacturing apparatus 4 using the predictive value generated with the first predictive value generator 204 or the second predictive value generator 205. The abnormality score is an element obtained by scoring the possibility of occurrence of abnormality at each point in time of the semiconductor manufacturing apparatus 4 based on the predictive value.

For example, the abnormality score calculator 206 calculates the size of residual between the predictive value and the summary value as the abnormality score. The abnormality score calculator 206 may calculate the absolute value of the residual between the predictive value and the summary value as the abnormality score. As another example, the abnormality score calculator 206 may use the square of the residual between the predictive value and the summary value as the abnormality score. As another example, the abnormality score calculator 206 may use a value (standardized residual) acquired by dividing the residual between the predictive value and the summary value by the standard deviation to standardize the residual as the abnormality score.

The abnormality score calculator 206 sets a predetermined confidence interval (for example, 95%) of the predictive value as the threshold. The abnormality score calculator 206 may set predetermined probability of distribution acquired by trimming the calculated abnormality score to remove the outliers as the abnormality determination line, that is, the threshold. As another example, the abnormality score calculator 206 may determine abnormality and normality in an unsupervised state by machine learning using a support vector machine or the like, to set the threshold. The detection unit 208 (described later) detects whether abnormality exists in accordance with whether the summary value falls within the set threshold.

This example illustrates the case where the abnormality detection apparatus 1 inputs the summary value to one of the first predictive value generator 204 and the second predictive value generator 205. Specifically, the example illustrates the case where the abnormality score calculator 206 calculates the abnormality score based on the predictive value generated with one of the first predictive value generator 204 and the second predictive value generator 205.

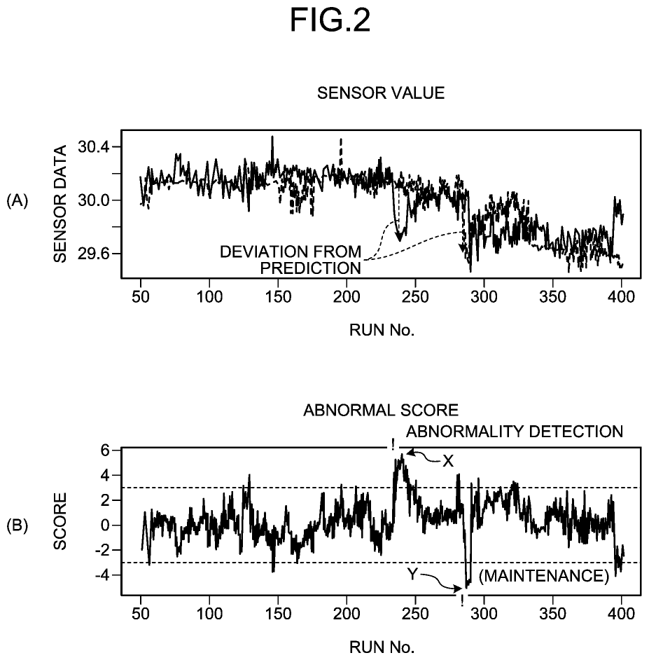

FIG. 2 is a diagram for explaining an abnormality score calculation process according to the first embodiment. In Part (A) of FIG. 2, the vertical axis indicates the sensor data (summary value) acquired for each of runs, and the horizontal axis indicates the run. In Part (A) of FIG. 2, the summary value is indicated with a solid line, and the predictive value is indicated with a dotted line.

Part (B) of FIG. 2 plots the magnitude of the residual between the summary value and the predictive value illustrated in Part (A), as the abnormality score. In Part (B) of FIG. 2, when the abnormality score falls out of the upper and the lower limit thresholds indicated with dotted lines, it is detected as abnormality. In Part (B), the abnormality score falls out of the upper and the lower limit thresholds at the parts indicated with arrows X and Y. The part indicated with the arrow X is a part in which the abnormality score exceeds the upper limit value and is detected as abnormality. The part indicated with the arrow Y is a part in which the observation value fluctuates due to maintenance, and is also detected as abnormality.

Example of Change Score Calculation Process

The change score calculator 207 calculates a change score serving as an index of change of the state of the semiconductor manufacturing apparatus 4. The change score calculator 207 applies statistical modeling, that is, a change point detection model to the summary value, to calculate a change score acquired by scoring the magnitude of change of the summary value. The change score calculator 207 calculates the change score based on the predictive value generated with the first predictive value generator 204 or the second predictive value generator 205.

For example, the change score calculator 207 may use the magnitude of the posterior probability calculated with the second predictive value generator 205 as the change score. In this case, the change score calculator 207 adopts the thresholds empirically set as the evaluation standard value for the change score.

In addition, for example, the change score calculator 207 may input the posterior probability calculated with the second predictive value generator 205 to the support vector machine (SVM), and extract the boundaries dividing the group in the normal state from the other groups as the thresholds.

As another example, the change score calculator 207 may use a Mahalanobis distance of the posterior probability as the change score.

As another example, the change score calculator 207 may use the score of the Bayesian change point acquired with a production division model using Bayes as the change score (See Barry D, Hartigan J. A, “A Bayesian Analysis for Change Point Problems.” Journal of the American Statistical Association, 35 (3), 309-319 (1993)). In this case, the change score calculator 207 trims the outliers of distribution of the past data to use the predetermined probability (for example, 5%) as the threshold. However, other empirically set fixed values may be used as the threshold, or the threshold may be set based on machine learning with a SVM as described above.

The method for calculating the change score is not particularly limited, as long as the part in which the waveform of the summary value greatly changes as the change point.

Example of Abnormality Detection Process and Abnormality Report Preparation Process

The detection unit 208 detects abnormality based on the abnormality score calculated with the abnormality score calculator 206 and the change score calculated with the change score calculator 207.

For example, the detection unit 208 determines whether the abnormality score calculated with the abnormality score calculator 206 has exceeded the threshold. The detection unit 208 also determines whether the change score calculated with the change score calculator 207 has exceeded the threshold.

When the detection unit 208 determines that one of the abnormality score and the change score has exceeded the threshold, the detection unit 208 notifies the warning unit 209 thereof. When the detection unit 208 determines that both the abnormality score and the change score have exceeded the threshold, the detection unit 208 also notifies the warning unit 209 thereof.

The detection unit 208 may be configured to notify the warning unit 209 of first level abnormality, in the case of determining that the abnormality score has exceeded the threshold but the change score has not exceeded the threshold, and in the case of determining that the abnormality score has not exceeded the threshold but the change score has exceeded the threshold. The detection unit 208 may be configured to notify the warning unit 209 of second level abnormality, when both the abnormality score and the change score have exceeded the threshold. The first level abnormality indicates abnormality lighter than the second level abnormality.

The detection unit 208 may be configured to distinguish the case where one of the two abnormality scores has exceeded the threshold from the case where both the two abnormality scores have exceeded the threshold, in the case of calculating the abnormality scores for the predictive values generated with the first predictive value generator 204 and the second predictive value generator 205. For example, the detection unit 208 notifies the warning unit 209 of first level abnormality, when one of two abnormal scores or the change score has exceeded the threshold. In addition, the detection unit 208 notifies the warning unit 209 of second level abnormality, when any two of two abnormal scores and the change score have exceeded the threshold. The detection unit 208 also notifies the warning unit 209 of third level abnormality, when all the two abnormal scores and the change score have exceeded the threshold. The degree of abnormality increases in a stepped manner from the first level to the third level.

The warning unit 209 transmits a warning to the remote server 3 through the communication unit 10, in accordance with notification from the detection unit 208. The warning unit 209 transmits warnings distinguishing the case of notifying the first level abnormality, the case of notifying the second level abnormality, and the case of notifying the third level abnormality from each other.

The abnormality report preparation unit 210 prepares an abnormality report accumulating results of the abnormality detection process in the abnormality detection apparatus 1 based on the information stored in the storage 30. The abnormality report prepared with the abnormality report preparation unit 210 is transmitted to the remote server 3 through the communication unit 10. The abnormality report prepared with the abnormality report preparation unit 210 is also output from the output unit 40.

The abnormality report preparation unit 210 may prepare an abnormality report for each of preset periods. The abnormality report preparation unit 210 may be configured to output an abnormality report when the detection unit 208 detects one of the first to the third level abnormalities. As another example, the abnormality report preparation unit 210 may be configured to prepare an abnormality report in accordance with input of a user's instruction. A specific example of the abnormality report will be described later.

Example of Information Stored in Storage 30

The storage 30 properly store therein information generated with the controller 20 and information received from the remote server 3. The storage 30 includes a semiconductor manufacturing apparatus information storage 31, an abnormality detection information storage 32, and an abnormality report storage 33.

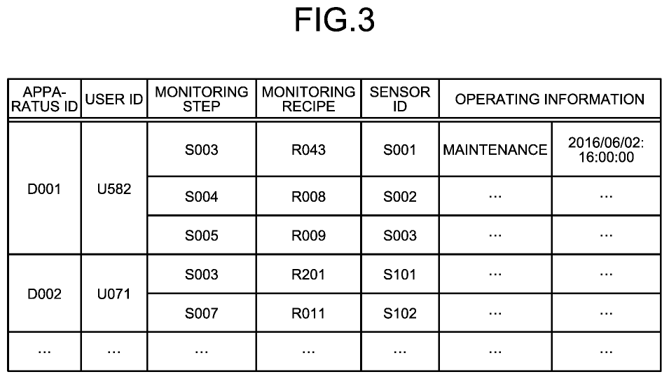

The semiconductor manufacturing apparatus information storage 31 stores therein semiconductor manufacturing apparatus information serving as information relating to the semiconductor manufacturing apparatus 4. FIG. 3 is a diagram illustrating an example of configuration of the semiconductor manufacturing apparatus information stored in the abnormality detection apparatus 1 according to the first embodiment.

The abnormality detection apparatus 1 stores therein semiconductor manufacturing apparatus information serving as information relating to the monitoring target apparatus in advance. For example, the abnormality detection apparatus 1 may adopt the structure in which information of the semiconductor manufacturing apparatus 4 is registered from the remote server 3 in the abnormality detection apparatus 1, or the structure in which the operator of the abnormality detection apparatus 1 inputs information of the monitoring target apparatus.

As illustrated in FIG. 3, the semiconductor manufacturing apparatus information includes information, such as “apparatus ID”, “user ID”, “monitoring step”, “monitoring recipe”, “sensor ID”, and “operating information”, and the like. The information “apparatus ID” is an identifier to uniquely identify each of the monitoring target apparatus. The information “user ID” is an identifier to uniquely identify the user or the operator who uses the monitoring target apparatus. The information “monitoring step” is information to identify the step serving as the monitoring target in the monitoring target apparatus. The information “monitoring recipe” is information to identify the recipe used in the monitoring step. The “monitoring step” and the “monitoring recipe” may be configured to be stored in association with the method of statistical modeling or the like applied in the abnormality detection process, to enable selection of the optimum statistical modeling method and/or the optimum threshold setting method for each of the steps and the recipes. The information “sensor ID” is information to uniquely identify the sensor provided in the monitoring target apparatus. The information “sensor ID” is set in association with the monitoring step and the monitoring recipe. The information “operating information” is information concerning the process executed in the monitoring target apparatus, and stored in the case where execution of any special process for the monitoring target apparatus is scheduled. For example, when maintenance is scheduled for a predetermined date and time, the information of “maintenance” and the date and time thereof is stored as the “operating information”. In the case where replacement of the components of the monitoring target apparatus is executed, information of the replacement and the date and time is stored as the “operating information”.

In the example of FIG. 3, the monitoring target apparatus identified with the apparatus ID “D001” is stored as the monitoring target apparatus of the user identified with the user ID “U582”. In addition, the monitoring step “5003” and the monitoring recipe “R043” are stored for the monitoring target apparatus. It is also stored that data measured with the sensor identified with the sensor ID “S001” is used for monitoring of the monitoring step “5003”. It is also stored that maintenance is executed from 16:00 on Jun. 2, 2016 for the monitoring target apparatus identified with the apparatus ID “D001”.

The semiconductor manufacturing apparatus information includes information for a plurality of monitoring target apparatuses used by a plurality of users. The abnormality detection apparatus 1 stores and manages, in a centralized manner, information for a plurality of monitoring target apparatuses used by a plurality of users, and consequently is enabled to execute abnormality detection of the monitoring target apparatuses through the network.

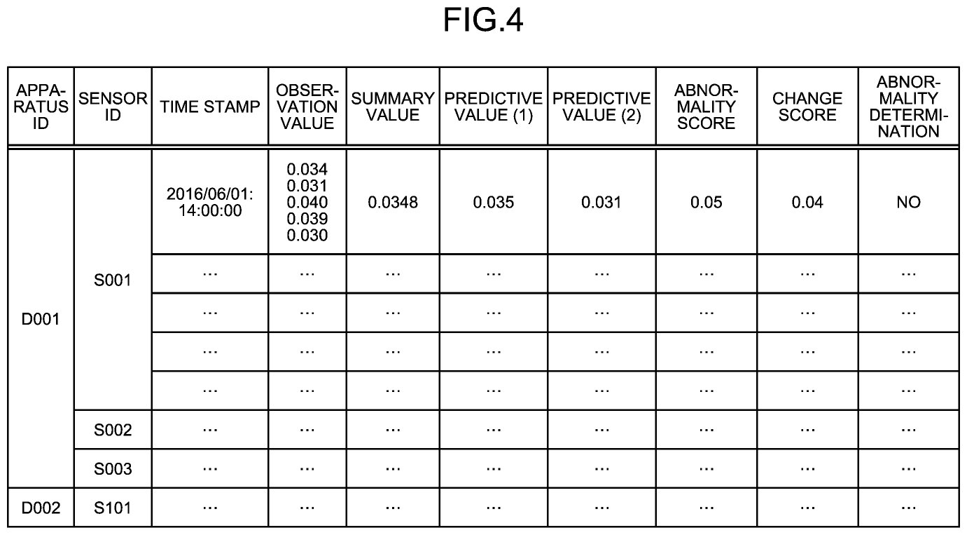

The abnormality detection information storage 32 stores abnormality detection information therein. FIG. 4 is a diagram illustrating an example of configuration of abnormality detection information stored in the abnormality detection apparatus 1 according to the first embodiment.

The abnormality detection information includes information, such as “apparatus ID”, “sensor ID”, “time stamp”, “observation value”, “summary value”, “predictive value (1)”, “predictive value (2)”, “abnormality score”, “change score”, and “abnormality determination”, and the like. The pieces of information “apparatus ID” and “sensor ID” are the same as the information included in the semiconductor manufacturing apparatus information. The information “time stamp” is information indicating the date and time at which the observation value is measured with the sensor. The information “time stamp” may be replaced with, for example, information specifying the corresponding run. The information “observation value” is an actual measurement value measured with the sensor identified with the “sensor ID” on the date and time specified with the “time stamp”. The information “summary value” is a value acquired by summarizing the corresponding “observation values”, such as a mean value. The information “predictive value (1)” is information of the predictive value generated based on the corresponding “observation values” and “summary value” through the first statistical modeling. The information “predictive value (2)” is information of the predictive value generated based on the corresponding “observation values” and “summary value” through the second statistical modeling. The information “abnormality score” is information of the abnormality score calculated based on the predictive value. The information “change score” is information of the change score calculated with the change score calculator 207. The information “abnormality determination” is information relating to abnormality detected with the detection unit 208 based on the abnormality score and the change score.

The example of FIG. 4 includes stored information relating to the observation values received at the date and time specified with the time stamp “2016/06/01:14:00:00” from the sensor identified with the sensor ID “S001” for the monitoring target apparatus identified with the apparatus ID “D001”. Specifically, the five values “0.034, 0.031, 0.040, 0.039, and 0.030” are stored as the observation values. In addition, the value “0.0348” serving as the mean value of the five observation values is stored as the summary value. The predictive values are generated with the first predictive value generator 204 and the second predictive value generator 205 based on the summary value, and stored. In addition, the abnormality score calculated with the abnormality score calculator 206 and the change score calculated with the change score calculator 207 are stored. In addition, the details of abnormality detected with the detection unit 208 based on the abnormality score and the change score are stored. In the example of FIG. 4, information “NO” indicating that no abnormality exists is stored. When abnormalities of the first level to the third level are detected, the information is stored in the item “abnormality detection” such that the abnormalities of the first level to the third level are distinguishable from each other.[0101] The predictive value, the abnormality score, and the change score are updated whenever the summary value is input, in the case of using the predictive value generated with the second predictive value generator 205.

The abnormality report storage 33 stores abnormality report information therein. The abnormality report information is prepared with the abnormality report preparation unit 210. The abnormality report information is information indicating a result of the abnormality detection process in the abnormality detection apparatus 1.

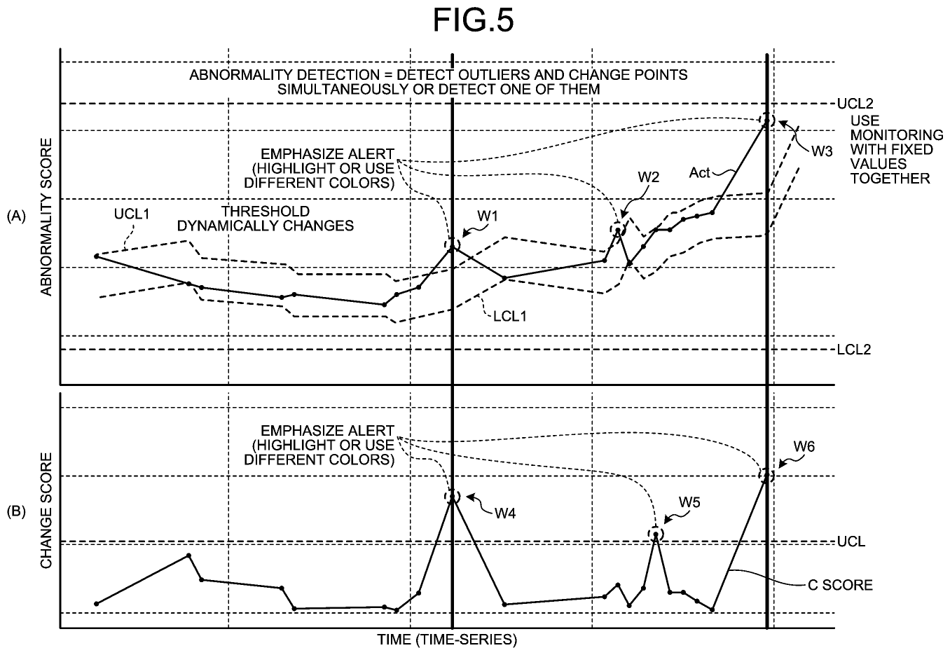

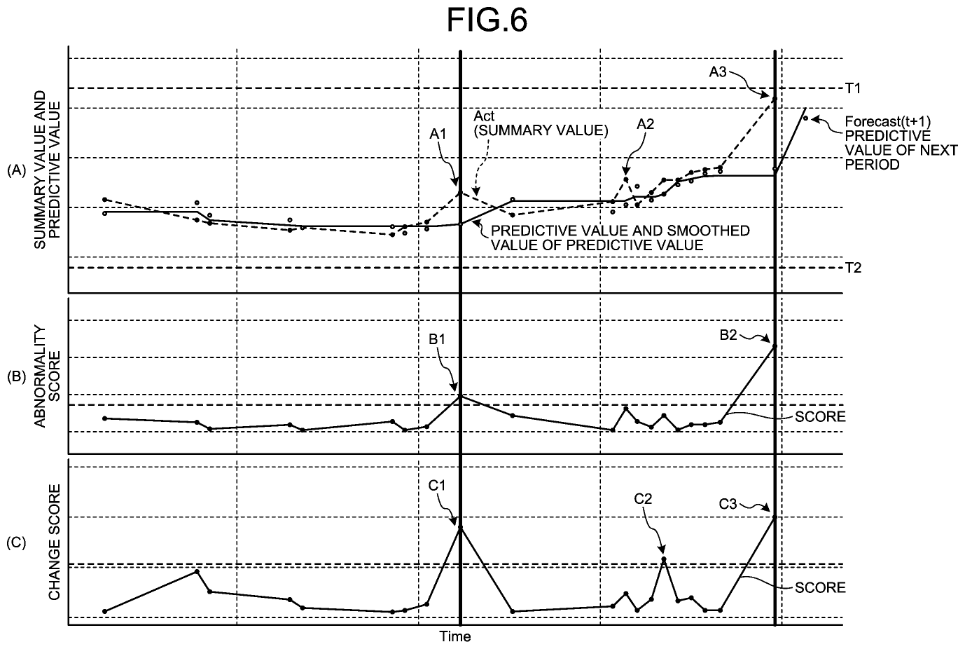

FIG. 5 is a diagram illustrating an example of information output by the abnormality detection process according to the first embodiment. FIG. 6 is a diagram for explaining an example of the predictive value, the abnormality score, and the change score generated by the abnormality detection process according to the first embodiment. The abnormality report information includes, for example, the information illustrated in FIG. 5 and FIG. 6.

Example of Abnormality Report

FIG. 5 is a diagram illustrating an example of information output by the abnormality detection method according to the first embodiment. The example of FIG. 5 plots results of 20 runs executed in a day in the semiconductor manufacturing apparatus 4. Part (A) of FIG. 5 illustrates the summary values in the respective runs and the upper and the lower limit thresholds set based on the predictive value. The upper and the lower limit thresholds are set based on a predetermined confidence interval of the predictive value, approximately 95% in this example. In the example of FIG. 5, the predictive value is calculated in the first predictive value generator 204 using a Kalman filter.

In Part (A) of FIG. 5, the line indicated with “Act” indicates the summary value. The lines “UCL1” and “LCL1” are upper and lower limit thresholds, respectively, set for abnormality score determination based on the predictive value. In Part (A) of FIG. 5, monitoring using the fixed values is also used in addition to the upper and the lower limit thresholds based on the predictive value. For this reason, the thresholds “UCL2” and “LCL2” are set in addition to the thresholds “UCL1” and “LCL1”. In Part (B) of FIG. 5, the line “C Score” indicates the change score, and the line “UCL” indicates the upper limit threshold of the change score.

In the example of FIG. 5, the abnormality detection apparatus 1 calculates the summary value (Act) for each of the runs based on the observation values. As illustrated in FIG. 5, the summary value fluctuates upward and downward at each of measurement points in time.

In addition, the abnormality detection apparatus 1 calculates the predictive value at each point in time based on the summary value. For example, up to the sixth plot from the left of FIG. 5, the summary value tends to gradually decrease while fluctuating upward and downward. For this reason, when the sixth summary value is input, the predictive value acquired by applying the statistical modeling is a value slightly smaller than the mean value of the first to the fourth plots (the center part of the upper and the lower limit thresholds). However, the summary value at the point in time of the seventh plot from the left increases from the summary value of the sixth plot. In addition, the summary value at the point in time of the eighth plot from the left further increases. For this reason, the predictive value is a value gently increasing, at the point in time of the eighth plot from the left. However, the summary value greatly increases at the point in time of the ninth plot from the left, and exceeds the upper limit threshold UCL1 based on the predictive value predicted at the point in time of the eighth plot. For this reason, in the abnormality detection apparatus 1, the warning unit 209 issues a warning at the point in time when determination based on the ninth summary value from the left is executed (the part indicated with the arrow W1 in Part (A) of FIG. 5). As described above, the abnormality detection apparatus 1 dynamically changes the upper and the lower limit thresholds applied to the summary value based on the predictive value. In addition in Part (A) of FIG. 5, also in the parts illustrated with arrows W2 and W3, the summary value Act has a value exceeding the upper limit threshold. As described above, the part at which the summary value Act exceeds the upper limit threshold UCL1 is highlighted in the abnormality report. For example, in Part (A) of FIG. 5, the parts of the arrows W1, W2, and W3 are displayed with a color different from the other plots, or highlighted.

As described above, the abnormality detection apparatus 1 according to the present embodiment eliminates noise and observation errors appearing in the observation values and the summary value, to estimate the state reflecting the trend of the state of the monitoring target apparatus more accurately and calculate the predictive value. In addition, the abnormality detection apparatus 1 sets the range of values that the summary value is expected to have, that is, thresholds, when the semiconductor manufacturing apparatus 4 normally operates, based on the predictive value. This structure enables the abnormality detection apparatus 1 to dynamically reset the threshold to be compared with the newly acquired summary value based on the past trend. This structure enables the abnormality detection apparatus 1 according to the embodiment to dynamically change the thresholds and detect abnormality with accuracy, even in the case of using the value having characteristics causing difficulty in fixedly setting the thresholds for abnormality detection.

In addition, in the example of Part (A) of FIG. 5, fixed thresholds are also used together with the thresholds changing based on the predictive value. This structure enables the abnormality detection apparatus 1 to execute monitoring using thresholds changing based on the predictive value as described above, while executing monitoring using fixed values as thresholds in the same manner as the conventional control chart, and further improves the accuracy of abnormality detection.

Part (B) of FIG. 5 illustrates an example in which the Bayesian change points of the summary value of Part (A) are scored. Because the summary value greatly increases between the eighth plot and the ninth plot from the left as illustrated in Part (A), a large increase corresponding to the ninth plot appears also in the change score. In addition, the value of the change score also increases at substantially the same points (the parts indicated with arrows W5 and W6 in Part (B) of FIG. 5) in time as the points indicated with the arrows W2 and W3 in the abnormality score. For example, in Part (B) of FIG. 5, the parts of the arrows W4, W5, and W6 are displayed with a color different from the other plots, or highlighted.

As described above, in the present embodiment, when abnormality detection is executed using the thresholds set based on the predictive value (that is, in the case of using the abnormality score, the summary value, the predictive value, and the residual and the like), the structure is enabled to detect a sudden change with high accuracy. In addition, the change score calculated based on the present embodiment enables extraction of change points at which the data changes. This structure enables the abnormality detection apparatus according to the embodiment to detect change occurring in data by abnormality detection using the abnormality score and the change score in combination to detect abnormality due to various causes with high accuracy. The abnormality detection apparatus 1 is enabled to further improve the accuracy of abnormality detection by using the thresholds set based on fixed values as well as the thresholds set based on the predictive value.

In addition, in the present embodiment, data in which the thresholds are dynamically and fixedly set to be compared with the summary value as illustrated in Part (A) is displayed in parallel with the data acquired by scoring the magnitude itself of change of the summary value as illustrated in Part (B). This structure enables the user to visually and intuitively recognize change occurring suddenly and change occurring gradually. In addition, the abnormality detection apparatus presents changes detected at different viewing points together, and determines absence/presence of abnormality to enable detection of occurrence of abnormality with higher accuracy.

The abnormality report may include the graph illustrated in FIG. 5, and may further include other pieces of information stored in the semiconductor manufacturing apparatus information storage 31 and the abnormality detection information storage 32.

The abnormality report may also include the graph illustrated in FIG. 6. FIG. 6 is a diagram for explaining an example of the predictive value, the abnormality score, and the change score generated by the abnormality detection process according to the first embodiment. Part (A) of FIG. 6 plots the summary value at each of points in time and predictive value (smoothed value of the predictive value) generated by applying the statistical modeling to the summary value. Part (A) of FIG. 6 also illustrates upper and lower thresholds T1 and T2 based on the fixed values. Part (B) of FIG. 6 plots the difference between the predictive value and the summary value illustrated in Part (A) as the abnormality score. Part (C) of FIG. 6 illustrates the change score acquired by calculating the likelihood change points for the summary value illustrated in Part (A) by Bayes estimation.

Unlike FIG. 5, part (A) in FIG. 6 illustrates the predictive value itself, not the thresholds dynamically set based on the predictive value, as the graph. In Part (A) of FIG. 6, the summary value greatly deviates from the predictive value in the parts indicated with arrows A1, A2, and A3. However, at any point in time, no summary value deviates from the range between the upper and the lower thresholds T1 and T2 based on the fixed values.

In Part (B) of FIG. 6, the abnormality score exceeds the threshold in parts B1 and B2 indicated with arrows. In addition, in Part (C) of FIG. 6, the change score exceeds the threshold in parts C1, C2, and C3 indicated with arrows. With the fixed thresholds T1 and T2 in Part (A) of FIG. 6, no normality or change can be detected in the parts B1 and B2 of Part (B) and the parts C1, C2, and C3 of Part (C). By contrast, the abnormality score and the change score are used together and, when any outlier occurs in one of the scores, user's attention is called. When any outlier occurs in both of the scores, a warning is issued. This structure enables issuance of “attention” at the point in time of C2, and issuance of “warning” at the point in time of B1 (C1) and B2 (C3). The abnormality report may display B1, B2, C1, C2, and C3 as abnormality points.

In the example of FIG. 6, each of Part (A) and Part (B) illustrates one predictive value, but the abnormality report may include two (A) and two (B), when the abnormality score is calculated for two predictive values.

Example of Flow of Abnormal Detection Process

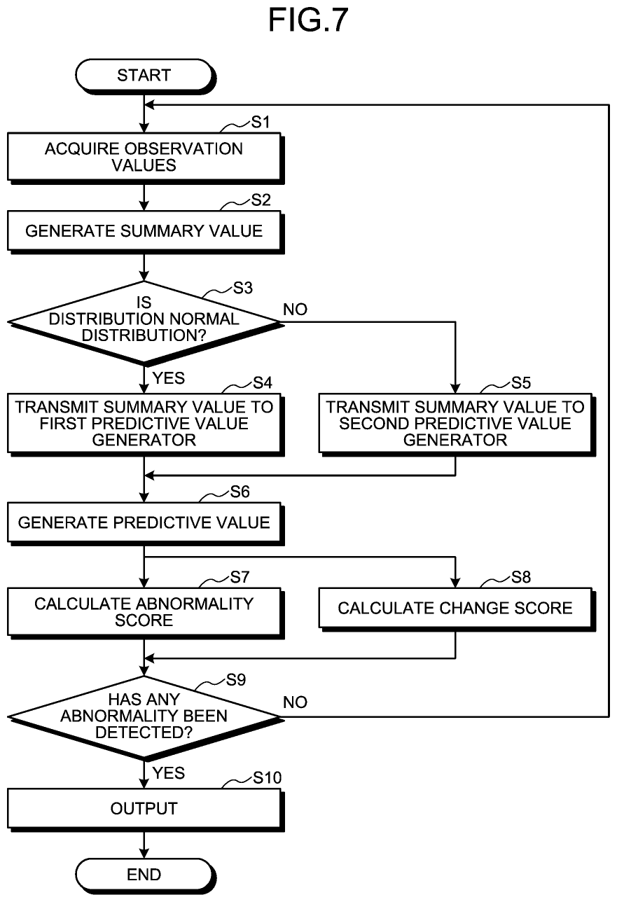

FIG. 7 is a flowchart illustrating an example of flow of abnormality detection process according to the first embodiment. First, the observation value acquisition unit 201 of the abnormality detection apparatus 1 acquires observation values of the sensors in the semiconductor manufacturing apparatus 4 through the remote server 3 (Step S1). The observation values acquired with the observation value acquisition unit 201 are transmitted to the summary value generator 202. The summary value generator 202 generates a summary value based on the observation values (Step S2). The summary value generated with the summary value generator 202 is transmitted to the selection unit 203. The selection unit 203 determines whether the distribution of the summary values is normal distribution or non-normal distribution (Step S3). When it is determined that the distribution is normal distribution (Yes at Step S3), the selection unit 203 transmits the summary value to the first predictive value generator 204 (Step S4). The first predictive value generator 204 generates a predictive value by applying the first statistical modeling to the summary value (Step S6). By contrast, when the selection unit 203 determines that the distribution is non-normal distribution (No at Step S3), the selection unit 203 transmits the summary value generated with the summary value generator 202 to the second predictive value generator 205 (Step S5). The second predictive value generator 205 generates a predictive value by applying the second statistical modeling to the summary value (Step S6). The predictive value generated with one of the first predictive value generator 204 and the second predictive value generator 205 is transmitted to the abnormality score calculator 206. The abnormality score calculator 206 calculates an abnormality score based on the predictive value (Step S7).

By contrast, the predictive value generated with the first predictive value generator 204 or the second predictive value generator 205 is also input to the change score calculator 207. The change score calculator 207 calculates a change score (Step S8). The detection unit 208 determines whether each of the scores exceeds the thresholds with reference to the abnormality score and the change score (Step S9). When the detection unit 208 determines that the score exceeds the threshold, that is, when the detection unit 208 detects abnormality (Yes at Step S9), the detection unit 208 notifies the warning unit 209 thereof, and the warning unit 209 transmits a warning to the remote server 3. The abnormality report preparation unit 210 outputs an abnormality report (Step S10). When the detection unit 208 determines that the score is equal to or smaller than the threshold, that is, when the detection unit 208 detects no abnormality (No at Step S9), the process returns to Step S1. The abnormality detection process ends in this manner.

### Alternative Example

In the first embodiment described above, the abnormality detection apparatus 1 includes the selection unit 203, and generates a predictive value using one of the first statistical modeling and the second statistical modeling. However, the selection unit 203 may be omitted, and the abnormality detection apparatus 1 may be configured to input the summary value to both the first predictive value generator 204 and the second predictive value generator 205. In addition, the abnormality score calculator 206 may be configured to calculate two abnormality scores based on the two predictive values generated with the first predictive value generator 204 and the second predictive value generator 205.

As another example, the abnormality detection apparatus may be configured to cause both the first predictive value generator 204 and the second predictive value generator 205 to generate a predictive value to calculate two abnormality scores, and regulate the parameters used for the statistical modeling based on the detection results of the detection unit 208 based on the calculated scores. In the first embodiment, as the statistical modeling, the first predictive value generator 204 uses filtering, and the second predictive value generator 205 uses MCMC. For this reason, it is expected that higher accuracy is achieved with the abnormality detection result using the predictive value generated with the second predictive value generator 205. For this reason, the abnormality detection apparatus may be configured to compare an abnormality detection result generated with the first predictive value generator 204 with an abnormality detection result generated with the second predictive value generator 205, and regulate the parameters of the statistical modeling used with the first predictive value generator 204 when the abnormality detection results are inconsistent with each other.

As another example, the abnormality detection apparatus may be configured to always cause both the first predictive value generator 204 and the second predictive value generator 205 to generate a predictive value, and perform abnormality detection based on two abnormality scores.

As another example, the abnormality detection apparatus may be configured to also execute determination using fixed thresholds as well as thresholds changing in accordance with the predictive value as described above with respect to the abnormality score. This structure enables the abnormality detection apparatus to detect change progressing gradually as well as abnormality occurring suddenly, and further improve the accuracy of abnormality detection.

Effects of First embodiment

As described above, the abnormality detection apparatus according to the present embodiment applies statistical modeling to the summary value acquired by summarizing the observation values acquired at predetermined timings during a process executed repeatedly in the monitoring target apparatus and serving as indexes of the operating state of the monitoring target apparatus. In addition, the abnormality detection apparatus detects presence/absence of abnormality of the monitoring target apparatus based on the predictive value. As described above, the abnormality detection apparatus according to the present embodiment monitors the state of the apparatus determined based on the observation values, instead of monitoring the observation values themselves. This structure enables the abnormality detection apparatus to find abnormality early without missing sudden change of the apparatus and/or change in state serving as the original detection target. This structure enables the abnormality detection apparatus to automatically achieve abnormality prediction and abnormality monitoring with high accuracy and efficiency. In addition, the abnormality detection apparatus according to the present embodiment is connected with the semiconductor manufacturing apparatus serving as the monitoring target through the network, and receives observation values observed in the semiconductor manufacturing apparatus. In addition, the abnormality detection apparatus monitors the state of the semiconductor manufacturing apparatus in real time based on the observation values. This structure enables the abnormality detection apparatus to achieve online monitoring in the semiconductor manufacturing apparatus.

In addition, the abnormality detection apparatus according to the embodiment does not execute abnormality detection directly based on the values (observation values) acquired from the monitoring target apparatus, but drives the summary value and the predictive value to execute abnormality detection. This structure enables the abnormality detection apparatus to quantize the operating state of the monitoring target apparatus, dynamically adapt the thresholds, and achieve automatic monitoring of the monitoring target apparatus, without being influenced by quality of actual measurement data depending on causes, such as the number of samples, noise, and observation errors.

In addition, the abnormality detection apparatus according to the embodiment generates a predictive value by applying the prediction model and the change point detection model as the statistical modeling. The abnormality detection apparatus according to the embodiment also applies the state space model and a Kalman filtering as the prediction model to generate a filtered value or a smoothed value as the predictive value. The abnormality detection apparatus according to the embodiment also estimates posterior distribution by the Markov Chain Monte Carlo Method as the statistical modeling, and generates one of the mean value, the mode, and the median of the posterior distribution as the predictive value. The abnormality detection apparatus according to the embodiment also generates, as the predictive value, a posterior mean value acquired by applying Bayes estimation to the summary value. As described above, the abnormality detection apparatus is enabled to automatically achieve abnormality prediction and abnormality monitoring with high accuracy and efficiency, by applying statistical modeling enabling extraction of trend of fluctuation of the summary value, even when the number of samples of the observation value is small or a loss exists.

In addition, the abnormality detection apparatus according to the embodiment successively executes the prediction model to update the predictive value whenever a new summary value is acquired, sets a predetermined confidence interval of the updated predictive value as the upper and the lower thresholds, and detects abnormality of the monitoring target apparatus when the updated predictive value falls out of the range of the upper and the lower thresholds. The abnormality detection apparatus according to the embodiment also detects abnormality when at least one of the residual between the predictive value and the summary value, the square of the residual, and the standardized residual between the predictive value and the summary value is larger than the threshold. This structure enables the abnormality detection apparatus to dynamically change the thresholds of abnormality detection, and achieve abnormality detection in consideration of the machine difference and the like.

In addition, the abnormality detection apparatus according to the embodiment detects abnormality when the score of the Bayesian change point of the summary value exceeds the threshold. This structure enables abnormality detection with high accuracy, without omission of detection even when a sudden change occurs as well as chronological change. The abnormality detection apparatus also executes detection with a plurality of abnormality detection standards used in combination, and is enabled to detect abnormality of different characteristics without omission and also detect the abnormality level. In addition, because the abnormality detection apparatus evaluates the state of the monitoring target apparatus from a plurality of viewpoints, the abnormality detection apparatus is enabled to achieve abnormality detection with higher accuracy than that in the case of determining abnormality with one standard.

Besides, the abnormality detection apparatus according to the embodiment outputs the change score and the abnormality score in the form of tables that are easy to visually recognize. This structure enables the user to visually recognize the point in time at which abnormality occurs and the degree of abnormality, and easily understand the state of the monitoring target apparatus. In addition, the abnormality detection apparatus according to the embodiment aligns the time axes of the change score and the abnormality score with each other and outputs the scores in line. This structure enables the user to associate abnormality detected from two different viewpoints, and easily understand change in state of the monitoring target apparatus.

In addition, the abnormality detection apparatus according to the embodiment acquires the latest observation result (observation values) whenever a process in the semiconductor manufacturing apparatus is finished to automatically update the thresholds used for abnormality detection. This structure removes the necessity for manually resetting the thresholds, and enables the abnormality detection apparatus to achieve abnormality monitoring without maintenance.

The embodiment described above illustrates the prediction model and the change point detection model as examples of the statistical modeling, but another statistical modeling method may be used. In addition, the predictive value is not always generated from the summary value, but statistical modeling may be directly applied to the observation values when it is possible in respect of the characteristic of the observation values.

In addition, the abnormality detection apparatus according to the embodiment includes two different predictive value generators generating predictive values using different statistical modeling methods. This structure enables the abnormality detection apparatus according to the embodiment to select a statistical modeling method suitable for the summary value in accordance with the characteristic of the summary value and generate a predictive value.

For example, the abnormality detection apparatus is enabled to execute abnormality detection using a prediction method using MCMC when an abnormality detection result with higher accuracy is required, and use a prediction method using filtering when a process with higher speed is required.

An extended Kalman filter, a particle filter, and any other filters may be used as the prediction method using filtering.

### First Alternative Example

In the first embodiment described above, occurrence of a specific event, such as maintenance of the semiconductor manufacturing apparatus 4, is not particularly considered. In the first alternative example, the abnormality detection apparatus is configured to discard an observation value directly after a specific event in consideration of the possibility that acquired data fluctuates due to occurrence of the specific event, such as maintenance of the semiconductor manufacturing apparatus 4. With respect to information as to occurrence of a specific event, it suffices that the abnormality detection apparatus is configured to acquire the information as an event log from the monitoring target apparatus and store the information in the storage.

Configuration and operations of an abnormality detection apparatus 1A according to the first alternative example are generally the same as those of the abnormality detection apparatus 1 according to the first embodiment, and an explanation of the same parts is omitted (see FIG. 1). In the abnormality detection apparatus 1A according to the first alternative example, operations of an observation value acquisition unit 201A included in a controller 20A is different from those of the observation value acquisition unit 201 of the first embodiment.

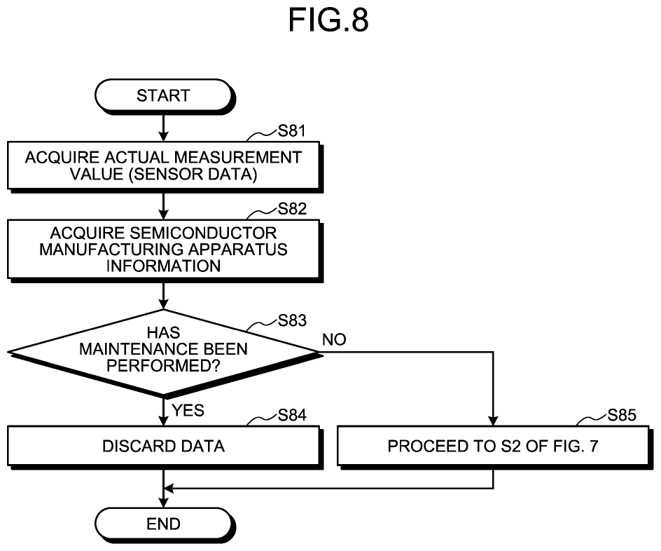

FIG. 8 is a flowchart for explaining a process in the abnormality detection apparatus 1A according to the first alternative example of the first embodiment.

As illustrated in FIG. 8, first, the abnormality detection apparatus 1A according to the first alternative example receives observation values of the sensors from the semiconductor manufacturing apparatus 4 through the remote server 3 (Step S81). The observation value acquisition unit 201A that has received the observation values thereafter acquires information of the semiconductor manufacturing apparatus 4 stored in the storage 30 (semiconductor manufacturing apparatus information storage 31) (Step S82). The observation value acquisition unit 201A determines whether the information acquired from the storage 30 includes information indicating that maintenance has been performed on the semiconductor manufacturing apparatus 4 at the measurement time of the acquired observation value (Step S83). When it is determined that the acquired information includes the information described above (Yes at Step S83), the observation value acquisition unit 201A does not transmit the acquired observation value to the other functional units, but discard the observation value (Step S84). By contrast, when it is determined that the acquired information includes no information described above (No at Step S83), the process proceeds to the abnormality detection process illustrated in FIG. 7 (Step S85). The process of the abnormality detection apparatus 1A according to the first alternative example ends in this manner.

The observation value acquisition unit 201A may be configured to acquire information of maintenance from the semiconductor manufacturing apparatus information storage 31 in advance, and discard observation values in a predetermined time before and after the maintenance as well as the observation values during the maintenance.

In addition, the abnormality detection apparatus 1A may be configured to reset the abnormality detection process up to that time and start a new process, when the observation value acquisition unit 201A determines that the acquired information includes information indicating that maintenance has been performed on the semiconductor manufacturing apparatus 4 (Yes at Step S83). Specifically, the abnormality detection apparatus 1A may be configured to once end the learning using the statistical modeling at the point in time when maintenance is performed, and newly start learning.

The observation value acquisition unit 201A may be configured to discard observation values acquired a predetermined number times thereafter, when the observation value acquisition unit 201A determines that the acquired information includes information indicating that maintenance has been performed on the semiconductor manufacturing apparatus 4 (Yes at Step S83). With this structure, data that may have fluctuated due to maintenance can be removed from the target of the abnormality detection process, while the abnormality detection process itself using the statistical modeling is continued. This structure enables improvement in abnormality detection.

As another example, the abnormality detection apparatus 1A may be configured to discard data serving as the target of abnormality detection when maintenance is executed after abnormality has been detected. For example, when the observation value acquisition unit 201A determines that the acquired information includes information indicating that maintenance has been performed on the semiconductor manufacturing apparatus 4 (Yes at Step S83), the observation value acquisition unit 201A further refers to the abnormality detection information storage 32. The observation value acquisition unit 201A determines whether any abnormality has been detected in a predetermined time period before the date and time of execution of the maintenance, for example, with reference to the information “time stamp” and “abnormality determination” included in the abnormality detection information. When it is determined that abnormality has been detected, the observation value acquisition unit 201A discards observation values acquired between the point in time at which abnormality has been detected and the time at which the maintenance has been finished. In addition, the observation value acquisition unit 201A repeatedly transmits the observation values directly before the time at which abnormality has been detected to the summary value generator 202, for a predetermined period of time. This structure enables estimation of the state of the semiconductor manufacturing apparatus 4 without data serving as the target of abnormality detection, that is, abnormal data, to execute statistical modeling, and improvement in accuracy of abnormality detection.

Effects of First Alternative Example

As described above, the detection accuracy of the abnormality detection apparatus 1A can be improved by removing the observation values during maintenance and in a predetermined time period before and after the maintenance from the determination target of abnormality detection.

### Second Alternative Example

In the first alternative example, the abnormality detection apparatus 1A is configured to discard the observation values during maintenance and/or observation values in a predetermined time period before and after the maintenance. Instead of this structure, the abnormality detection apparatus may be configured to output no warning, although the observation values are still input, during maintenance and in a predetermined period after the maintenance. The example with a structure in which no warning is output after the maintenance will be explained hereinafter as the second alternative example.

Configuration and operations of an abnormality detection apparatus 1B according to the second alternative example are generally the same as those of the abnormality detection apparatus 1 according to the first embodiment, and an explanation of the same parts is omitted (see FIG. 1). In the abnormality detection apparatus 1B according to the second alternative example, operations of a warning unit 209B included in a controller 20B is different from those of the warning unit 209 of the first embodiment.

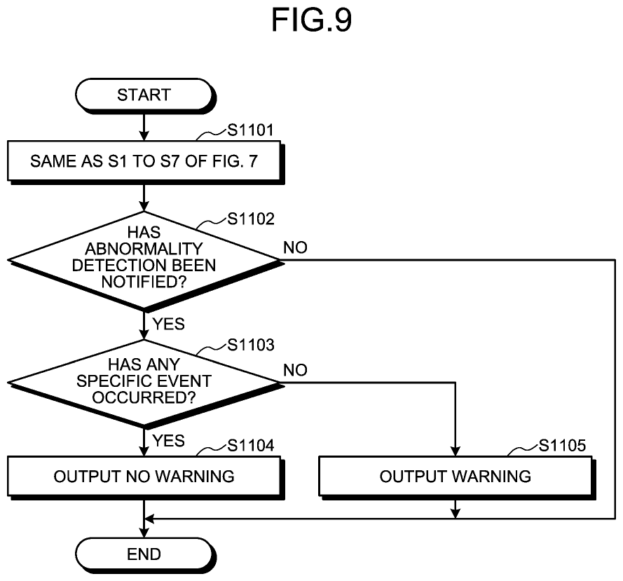

FIG. 9 is a flowchart for explaining a process in the abnormality detection apparatus 1B according to the second alternative example.

As illustrated in FIG. 9, first, the abnormality detection apparatus 1B according to the second alternative example receives observation values of the sensors from the semiconductor manufacturing apparatus 4 through the remote server 3, and executes the same processes as those at Steps S1 to S7 of FIG. 7 (Step S1101). Thereafter, the warning unit 209B determines whether abnormality detection has been notified from the detection unit 208 (Step S1102). When the warning unit 209B determines that no abnormality detection has been notified (No at Step S1102), the process ends. By contrast, when the warning unit 209B determines that abnormality detection has been notified (Yes at Step S1102), the warning unit 209B thereafter determines whether any specific event has occurred before acquisition of the summary value (Step S1103). For example, the warning unit 209B refers to the “operating information” in FIG. 3, and determines whether the operating information includes information indicating that maintenance has been performed in a predetermined period of time from the time when the summary value has been acquired. When the warning unit 209B determines that a specific event has occurred (Yes at Step S1103), the warning unit 209B ends the process without outputting any warning (Step S1104). By contrast, when the warning unit 209B determines that no specific event has occurred (No at Step S1103), the warning unit 209B outputs a warning (Step S1105), and ends the process.

As described above, the abnormality detection apparatus may be configured to output no warning for a predetermined period of time after a specific event, when the specific event, such as maintenance occurs and the observation values are expected to be unstable.

As another example, the abnormality detection apparatus may be configured to initialize the abnormality detection process once, after a specific event occurs. For example, the abnormality detection apparatus may be configured to erase data once, such as the predictive value stored in the abnormality detection apparatus, after execution of maintenance, to apply the statistical modeling only to newly input data. As another example, the abnormality detection apparatus may be configured to initialize the abnormality detection process after an output of a warning and a specific event successively occur, such as the case where a warning is output and thereafter maintenance is executed. As another example, the abnormality detection apparatus may be configured to exclude the observation values, the summary value, and the predictive value serving as the target of the warning and the observation values, the summary value, and the predictive value acquired during execution of the specific event, when an output of a warning and a specific event successively occur. This structure prevents unstable accuracy of detection results due to fluctuations of conditions caused by maintenance or the like.

Computer Program

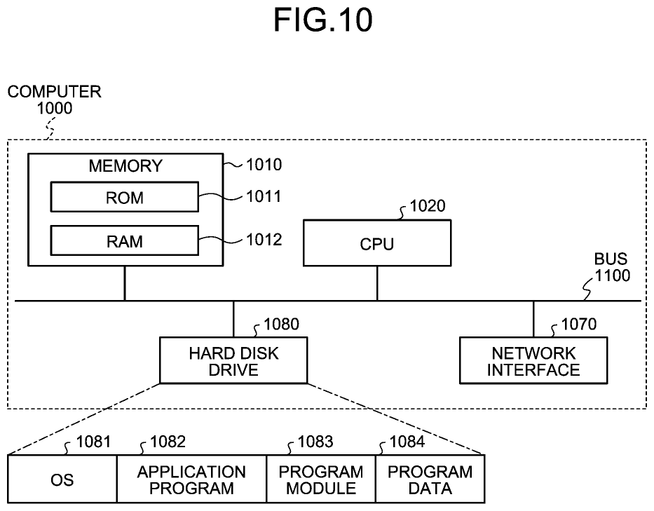

FIG. 10 is a diagram illustrating that information processing with an abnormality detection program according to the first embodiment is concretely achieved using a computer. As illustrated in FIG. 10, a computer 1000 includes, for example, a memory 1010, a central processing unit (CPU) 1020, a hard disk drive 1080, and a network interface 1070. The units of the computer 1000 are connected with a bus 1100.

As illustrated in FIG. 10, the memory 1010 includes a ROM 1011 and a RAM 1012. The ROM 1011 stores therein a boot program, such as a basic input output system (BIOS).

As illustrated in FIG. 10, the hard disk drive 1080 stores therein, for example, an OS 1081, an application program 1082, a program module 1083, and program data 1084. Specifically, the abnormality detection program according to the disclosed embodiment is stored in, for example, the hard disk drive 1080, as the program module 1083 describing commands to be executed with a computer.

In addition, the data used for information processing performed with the abnormality detection program is stored in, for example, the hard disk drive 1080, as the program data 1084. The CPU 1020 reads the program module 1083 and the program data 1084 stored in the hard disk drive 1080 onto the RAM 1012, when necessary, to execute various processes.

The program module 1083 and/or the program data 1084 relating to the abnormality detection program are not always stored in the hard disk drive 1080. For example, the program module 1083 and/or the program data 1084 may be stored in a detachable storage medium. In this case, the CPU 1020 reads data through the detachable storage medium, such as a disk drive. In the same manner, the program module 1083 and/or the program data 1084 relating to the abnormality detection program may be stored in another computer connected through a network (such as a local area network (LAN) and a wide area network (WAN)). In this case, the CPU 1020 reads various data by accessing the computer through the network interface 1070.

Others

The abnormality detection program explained in the present embodiment can be distributed through a network, such as the Internet. The abnormality detection program may be recorded on a computer-readable recording medium, such as a hard disk, a flexible disk (FD), a CD-ROM, a MO, and a DVD, and executed by being read from the recording medium with a computer.

In the processes explained in the present embodiment, the whole or part of the process explained as an automatically executed process may be manually executed. As another example, the whole or part of the process explained as a manually executed process may be automatically executed by a publicly known method. In addition, the process, the control process, the specific name, and information including various types of data and parameters illustrated in the document described above and the drawings may be changed as desired except for the case particularly described.

Further effects and alternative examples may be easily derived by the skilled person. For this reason, more extensive modes of the present invention are not limited to the specific details or typical embodiments expressed and described above. Accordingly, various changes are possible without departing from the concept or range of the general invention defined with the attached claims and equivalents thereof.

### REFERENCE SIGNS LIST

1, 1A, 1B ABNORMALITY DETECTION APPARATUS
10 COMMUNICATION UNIT
20, 20A, 20B CONTROLLER
201, 201A OBSERVATION VALUE ACQUISITION UNIT
202 SUMMARY VALUE GENERATOR
203 SELECTION UNIT
204 FIRST PREDICTIVE VALUE GENERATOR
205 SECOND PREDICTIVE VALUE GENERATOR
206 ABNORMALITY SCORE CALCULATOR
207 CHANGE SCORE CALCULATOR
208 DETECTION UNIT
209, 209B WARNING UNIT
210 ABNORMALITY REPORT PREPARATION UNIT
30 STORAGE
31 SEMICONDUCTOR MANUFACTURING APPARATUS INFORMATION STORAGE
32 ABNORMALITY DETECTION INFORMATION STORAGE
33 ABNORMALITY REPORT STORAGE
40 OUTPUT UNIT
2 NETWORK
3 REMOTE SERVER
4 SEMICONDUCTOR MANUFACTURING APPARATUS

1. A non-transitory computer readable recording medium having stored therein an abnormality detection program that causes a computer to execute a process comprising:
applying statistical modeling to a summary value acquired by summarizing observation values, estimating a state in which noise is removed from the summary value, generating a predictive value acquired by predicting a summary value of a next period based on the estimating, updating the predictive value every time a new summary value is acquired, the observation values being acquired at predetermined timings during a process executed repeatedly in a monitoring target apparatus and serving as indexes of an operating state of the monitoring target apparatus; and
detecting presence/absence of abnormality of the monitoring target apparatus based on the predictive value by setting a confidence interval of the updated predictive value as a threshold.

2. (canceled)

3. The computer readable recording medium according to claim 1, wherein, the applying applies a prediction model using filtering as the statistical modeling.

4. The computer readable recording medium according to claim 3, wherein, the generating generates a filtered value or a smoothed value acquired by Kalman filtering, as the predictive value.

5. The computer readable recording medium according to claim 1, wherein, the applying applies a prediction model using Markov Chain Monte Carlo Method as the statistical modeling to generate the predictive value.

6. computer readable recording medium according to claim 5, wherein, the estimating estimates posterior distribution with the prediction model using Markov Chain Monte Carlo Method, to generate one of a mean value, a mode, and a median of the posterior distribution as the predictive value.

7. The computer readable recording medium according to claim 1, wherein, the detecting detects abnormality when at least one of a residual between the predictive value and the summary value, square of the residual, and a standardized residual between the predictive value and the summary value is larger than a threshold.

8. The computer readable recording medium according to claim 1, wherein, the applying applies a prediction model and a change point detection model as the statistical modeling.

9. The computer readable recording medium according to claim 1, wherein, the detecting detects abnormality when a score of a Bayesian change point of the summary value exceeds a threshold.

10. An abnormality detection method executed with a computer, the method comprising:
a predictive value generation process of applying statistical modeling to a summary value acquired by summarizing observation values, estimating a state in which noise is removed from the summary value, and generating a predictive value acquired by predicting a summary value of a next period based on the estimating, updating the predictive value every time a new summary value is acquired, the observation values being acquired at predetermined timings during a process executed repeatedly in a monitoring target apparatus and serving as indexes of an operating state of the monitoring target apparatus; and
detecting presence/absence of abnormality of the monitoring target apparatus based on the predictive value by setting a confidence interval of the updated predictive value as a threshold.

11. The abnormality detection method according to claim 10, further comprising:
an output process of outputting, with the computer, a table in which a threshold and at least one of a residual between the predictive value and the summary value, square of the residual, and a standardized residual between the predictive value and the summary value are displayed in a vertical axis, and a time axis is displayed in a horizontal axis.

12. The abnormality detection method according to claim 10, further comprising:
an output process of outputting, with the computer, a table in which a score of a Bayesian change point of the summary value and a threshold are displayed in a vertical axis, and a time axis is displayed in a horizontal axis.

13. The abnormality detection method according to claim 10, further comprising:
an output process of outputting, with the computer, a first table in which a threshold and at least one of a residual between the predictive value and the summary value, square of the residual, and a standardized residual between the predictive value and the summary value are displayed in a vertical axis, and a time axis is displayed in a horizontal axis, and a second table in which a score of a Bayesian change point of the summary value and a threshold are displayed in a vertical axis, and a time axis is displayed in a horizontal axis, as an image in which the first table and the second table are aligned with the time axes thereof aligned.

14. An abnormality detection apparatus comprising:
a memory; and
a processor coupled to the memory to perform a process comprising:
applying statistical modeling to a summary value acquired by summarizing observation values, estimating a state in which noise is removed from the summary value, generating a predictive value acquired by predicting a summary value of a next period based on the estimating, updating the predictive value every time a new summary value is acquired, the observation values acquired at predetermined timings during a process executed repeatedly in a monitoring target apparatus and serving as indexes of an operating state of the monitoring target apparatus; and
detecting presence/absence of abnormality of the monitoring target apparatus based on the predictive value by setting a confidence interval of the updated predictive value as a threshold.

15. The abnormality detection apparatus according to claim 14, the process further comprising:
preparing a table in which a threshold and at least one of a residual between the predictive value and the summary value, square of the residual, and a standardized residual between the predictive value and the summary value are displayed in a vertical axis, and a time axis is displayed in a horizontal axis; and
outputting the table prepared in the preparing.

16. The abnormality detection apparatus according to claim 14, the process further comprising:
preparing a table in which a score of a Bayesian change point of the summary value and a threshold are displayed in a vertical axis, and a time axis is displayed in a horizontal axis; and
outputting the table prepared in the preparing.

17. The abnormality detection apparatus according to claim 14, the process further comprising:
preparing a first table in which a threshold and at least one of a residual between the predictive value and the summary value, square of the residual, and a standardized residual between the predictive value and the summary value are displayed in a vertical axis and a time axis is displayed in a horizontal axis, and a second table in which a score of a Bayesian change point of the summary value and a threshold are displayed in a vertical axis and a time axis is displayed in a horizontal axis; and
outputting the first table and the second able as an image in which the first table and the second table are aligned with the time axes thereof aligned.
